(19) United States
(12) Patent Application Publication
(10) Pub. No.: US 2026/0225928 A1
(43) Pub. Date: Aug. 6, 2026

(54) ALKALINITY GENERATION SYSTEMS AND METHODS

(71) Applicant: Pentair Water Pool and Spa, Inc., Golden Valley, MN (US)

(72) Inventor: Caleb Ray, Apex, NC (US)

(21) Appl. No.: 19/466,884

(22) Filed: Feb. 2, 2026

Related U.S. Application Data
(60) Provisional application No. 63/751,914, filed on Jan. 31, 2025.

(51) Int. Cl. C02F 1/66; C02F 1/00; C02F 1/68; C02F 103/42

(52) U.S. Cl. CPC C02F 1/66; C02F 1/008; C02F 1/685; C02F 2103/42; C02F 2209/06; C02F 2209/07

(57) ABSTRACT

A system and method for alkalinity generation in an aquatic application is disclosed. The alkalinity generation system includes a controller communicatively coupled to a first chemical distribution mechanism designed to deliver a pH increaser, a second chemical distribution mechanism designed to deliver an acid. The alkalinity generation system may include a third chemical distribution mechanism designed to deliver an alkalinity modifier to the aquatic application. The controller is designed to control each of the first, second, and third chemical distribution mechanisms to dose the aquatic application with the pH increaser, the acid, and the alkalinity modifier to adjust at least one of a pH value and an alkalinity level in the aquatic application.

### CROSS-REFERENCE TO RELATED APPLICATIONS

This application claims priority from U.S. Provisional Patent Application Ser. No. 63/751,914, filed on Jan. 31, 2025, entitled “ALKALINITY GENERATION SYSTEM AND METHOD,” currently pending, the entirety of which is incorporated herein by reference.

### TECHNICAL FIELD

This disclosure generally relates to controlling the water chemistry of an aquatic environment and more particularly to systems and methods for controlling the alkalinity and pH values of a swimming pool or spa.

### BACKGROUND

Many aquatic applications utilize monitoring of levels of certain chemicals within the water. Alternatively, chemical characteristics of the water associated with certain chemicals may be monitored (e.g., a pH value, an alkalinity value, etc.). In some instances, water treatment chemicals may be automatically added to the water with an automated chemical delivery system in response to detected chemical levels or water chemical characteristics determined as part of the monitoring process.

For example, in a pool or spa setting, the pH value of the water in the system can be determined, and a pH increaser and/or an acid can be added to adjust the pH value. Further, in some instances, the alkalinity value of the water can be monitored because the alkalinity is an indicator of the pH stability. In other words, alkalinity measures how much acid a body of water can neutralize before the pH value changes. Thus, it can be beneficial to maintain the alkalinity within a desired range so that the water can resist pH value fluctuations due to changes in the acid concentration in the water.

Alkalinity is a quality of water that is made up of any compound that can neutralize acids, such as bases, including bicarbonate, borate, cyanuric acid, hydroxides, and the like. In conventional pool systems, it can be desirable to have a large amount of a weak base so that the pool water has a strong pH buffering capacity without resulting in a high pH value that can irritate bathers. Typically, the alkalinity in a pool system is made up of bicarbonate, which is established through the addition of sodium bicarbonate. Thus, some conventional pool systems can include alkalinity generation systems for adding sodium bicarbonate to the pool water.

However, sodium bicarbonate can be challenging to use because it has poor solubility in water. Thus, dissolving sodium bicarbonate into a solution and using existing liquid chemical delivery systems may not be practical because a large amount of the sodium bicarbonate solution may be needed. Further, dry powder sodium bicarbonate can clump when exposed to moisture. Therefore, dry powder chemical delivery systems may not be ideal for dosing pool water with sodium bicarbonate because pool systems and their associated equipment tend to be moist and can be susceptible to clogging with wetted sodium bicarbonate. Moreover, dry sodium bicarbonate powder can form into a hard rock-like block if it is wetted and then dried. The hard block of sodium bicarbonate can be difficult to crush into a powder and/or dissolve again. Accordingly, sodium bicarbonate is traditionally added to pool systems manually because current pool chemical delivery systems cannot reliably dose the pool water with sodium bicarbonate.

Therefore, there is a need for an alkalinity generation system and method that can produce bicarbonate in pool water without using sodium bicarbonate. Further, there is a need for a system and method for automatically monitoring and controlling the alkalinity in a pool system via the alkalinity generation system.

### SUMMARY OF THE INVENTION

An alkalinity generation system is disclosed. The alkalinity generation system includes a first chemical distribution mechanism designed to deliver a pH increaser to the aquatic application, a second chemical distribution mechanism designed to deliver an acid to the aquatic application, and a third chemical distribution mechanism designed to deliver an alkalinity modifier to the aquatic application. The alkalinity generation system further includes at least one sensor designed to sense a pH value and an alkalinity level of the aquatic application. A controller included in the alkalinity generation system can be designed to control a dosage rate of at least one of the pH increaser, the acid, and the alkalinity modifier based on the sensed pH value and alkalinity level.

In some aspects, each of the first chemical distribution mechanism, the second chemical distribution mechanism, and the third chemical distribution mechanism are each independently provided in the form of a pump, a vapor diffuser, or an air stone and valve system.

In another aspect, each of the first chemical distribution mechanism, the second chemical distribution mechanism, and the third chemical distribution mechanism are in fluid communication with a plurality of chemical containers designed to contain one or more water treatment chemicals.

In some instances, the plurality of chemical containers include a first chemical container designed to contain the pH increaser, a second chemical container designed to contain the acid, and a third chemical container designed to contain the alkalinity modifier.

In another example, the pH increaser is selected from the group consisting of potassium carbonate, sodium carbonate, and potassium hydroxide.

In yet another aspect, the acid is hydrochloric acid.

In still another instance, the alkalinity modifier is gaseous carbon dioxide.

In some examples, the at least one sensor is a colorimeter sensor.

In some aspects, the alkalinity generation system includes a second sensor designed to sense at least one of the pH value, the alkalinity level, a water temperature, a flow rate, and a pressure.

In another instance, an alkalinity generation system is disclosed. The alkalinity generation system includes a first chemical distribution mechanism designed to deliver a pH increaser to the aquatic application, a second chemical distribution mechanism designed to deliver an acid to the aquatic application, a third chemical distribution mechanism designed to deliver an alkalinity modifier to the aquatic application, a sensor designed to sense one or more water quality parameters, and a controller. The controller is communicatively coupled to the sensor, the first chemical distribution mechanism, the second chemical distribution mechanism, and the third chemical distribution mechanism. The controller is designed to monitor a water quality of the aquatic application using the sensor, determine at least one water quality parameter of the one or more water quality parameters that are out of compliance with a setpoint value, determine a chemical treatment plan designed to bring the out of compliance water quality parameter into compliance with the setpoint value, and implement the chemical treatment plan.

In some aspects, the one or more water quality parameters include at least one of a pH value, an alkalinity level, a water temperature, a flow rate, and a pressure.

In another aspect, the chemical treatment plan includes determining an adjusted dosage rate of at least one of the pH increaser, the acid, and the alkalinity modifier.

In still other instances, implementing the chemical treatment plan includes controlling one or more of the first chemical distribution mechanism, the second chemical distribution mechanism, and the third chemical distribution mechanism to deliver the adjusted dosage rate of at least one of the pH increaser, the acid, and the alkalinity modifier.

Further provided is a method for controlling a water quality of an aquatic application. The method includes the steps of sensing a plurality of water quality parameters including a pH value and an alkalinity level, determining the alkalinity level is above an alkalinity setpoint range, determining whether the pH value is above or below a pH setpoint range, determining a chemical treatment plan designed to bring the alkalinity level within the alkalinity setpoint range, and the pH value within the pH setpoint range, and implementing the chemical treatment plan by controlling one or more chemical distribution mechanisms to adjust a dosage rate of one or more of a pH increaser, an acid, and an alkalinity modifier.

In one aspect, determining the pH value is above or below the pH setpoint range includes determining the pH value is above the pH setpoint range.

In another aspect, implementing the chemical treatment plan includes increasing an acid dosage rate of the acid.

In still another aspect, determining the pH value is above or below the pH setpoint range includes determining the pH value is below the pH setpoint range.

In some examples, the chemical treatment plan includes increasing an acid dosage rate.

In some instances, determining the alkalinity level is within the alkalinity setpoint range.

In still another instance, implementing the chemical treatment plan includes increasing a pH increaser dosage rate of the pH increaser.

In some cases, the alkalinity setpoint range is imparted with a value of about 80 ppm to about 120 ppm.

In certain instances, determining the chemical treatment plan includes bringing the pH value of the aquatic application within the pH value setpoint range, and the pH setpoint range is imparted with a value of about 7.2 to about 7.8.

### DESCRIPTION OF THE DRAWINGS

FIG. 1 is a schematic block diagram of an alkalinity generation system according to the disclosure herein;

FIG. 2 is a schematic block diagram of another alkalinity generation system according to the disclosure herein;

FIG. 3 is a flow diagram of a method for monitoring and initiating a chemical treatment plan via the alkalinity generation system of FIG. 1 or FIG. 2;

FIG. 4 is a flow diagram of a method for lowering an alkalinity level in water via the alkalinity generation system of FIG. 1 or FIG. 2; and

FIG. 5 is a flow diagram of a method for raising an alkalinity level in water via the alkalinity generation system of FIG. 1 or FIG. 2.

These and other aspects and advantages of the present disclosure will become apparent to those skilled in the art after considering the following detailed description in connection with the accompanying drawings.

### DETAILED DESCRIPTION

Before any instances of the invention are explained in detail, it is to be understood that the invention is not limited in its application to the details of construction and the arrangement of components set forth in the following description or illustrated in the following drawings. The invention is capable of other instances and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use instances of the invention. Various modifications to the illustrated instances will be readily apparent to those skilled in the art, and the generic principles herein can be applied to other instances and applications without departing from instances of the invention. Thus, instances of the invention are not intended to be limited to instances shown but are to be accorded the widest scope consistent with the principles and features disclosed herein. The following detailed description is to be read with reference to the figures, in which like elements in different figures have like reference numerals. The figures, which are not necessarily to scale, depict selected instances and are not intended to limit the scope of instances of the invention. Skilled artisans will recognize the examples provided herein have many useful alternatives and fall within the scope of instances of the invention.

Aquatic applications include water that is contained within a structure, such as a swimming pool, whereby the water is defined by a specific chemical composition suitable to the specific aquatic application. In some instances, it may be desirable to keep water that is present within the aquatic application at a specified level with respect to its chemical makeup and other associated water quality parameters such as pH value and alkalinity. To initially set up and/or maintain the water at the specified levels, a controller can be configured to determine an initial water quality level and automatically add one or more water treatment chemicals to the pool water via a pump to effectuate a change in the chemical composition of the water. Thus, the chemical levels and/or water quality can be periodically or continuously monitored and adjusted as the water quality changes. Further, in some instances, the controller can be configured to inhibit the addition of water treatment chemicals once the water quality reaches the desired level.

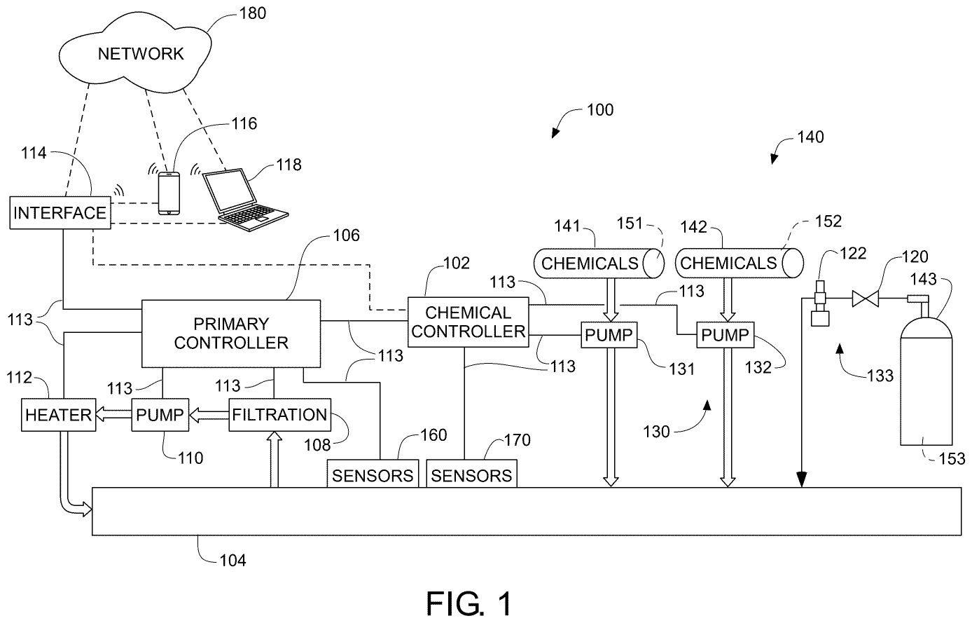

Turning to FIG. 1, an alkalinity generation system 100 for monitoring water quality and controlling the dosage rate of a plurality of water treatment chemicals is illustrated. As shown, the alkalinity generation system 100 may include a chemical controller 102. The chemical controller 102 may be generally used in conjunction with one or more aquatic applications (e.g., an aquatic application 104), for example, a pool, a hot tub, a spa tub, a fountain, or any other fluid application where regulation of one or more chemicals may be beneficial. The one or more aquatic applications 104 may be provided with a volume of water. The volume of water may be imparted with a pH value and an alkalinity level. The chemical controller 102 can be communicatively coupled to a primary controller 106 that communicates with or otherwise operates other devices designed to control various aspects of the aquatic application 104. For example, the primary controller 106 can be communicatively coupled with and/or designed to control one or more of a filtration device 108, a pump 110, a heater 112, and/or any number of other devices and systems used with the aquatic application 104. The chemical controller 102 may be in electronic communication with the primary controller 106 and the pump via a plurality of control connections 113. The primary controller 106 may be in electronic communication with the filtration device 108, the pump 110, and the heater 112 via the plurality of control connections 113. It is to be understood that the plurality of control connections 113 may be wired or wireless electronic communication pathways.

The primary controller 106 can include an integral or separate control interface 114 to enable control of the system by a user and/or to provide data (e.g., status, temperatures, settings, levels, etc.) to the user. The primary controller 106 may be in electronic communication with the interface 114 via one of the plurality of control connections 113. The primary controller 106 may be provided in the form of the IntelliChem® Water Chemistry Controller. The primary controller may be processor-based and be operated or controlled in accordance with U.S. patent application Ser. No. 18/342,675, which is incorporated herein by reference. In some instances, the control interface 114 can also communicate directly with the chemical controller 102. In other instances, the chemical controller 102 can communicate with the primary controller 106 instead. For example, the chemical controller 102 can be designed to relay instructions to the plurality of system devices (filtration device 108, pump 110, heater 112) through the primary controller 106 or from the interface 114.

Still referring to FIG. 1, the primary controller 106 and the interface 114 may interface either directly over a network 180, for example, a local area network or a cloud network. The primary controller 106 may be a gateway, a hub, a switch, a router, a server, or other connection device to allow integration, monitoring, and control of multiple aspects of the alkalinity generation system 100. In some instances, the primary controller 106 may be part of a control system comprising a processor, memory, output/input device, and power supply. In some instances, the primary controller 106 may be located external to the alkalinity generation system 100 and may be connected via Bluetooth, WiFi, internet, remote control, a wired connection, and/or other similar communication technologies.

The interface 114 can be provided in the form of a touch-screen interface that a user can interact with to control the alkalinity generation system 100. In some instances, the interface 114 may be capable of providing, communicating with, or being incorporated into other user interfaces via other user devices, such as a smartphone 116, a computer 118, a tablet device (not shown), or other user devices. Such communication may be effected through one or more wired connections or via a wireless connection, either directly to the primary controller 106 or through one or more remote servers providing an online control service. In some instances, communication may similarly be affected between the user devices (e.g., the smartphone 116 or the computer 118) and the chemical controller 102.

The primary controller 106 may be configured or designed to control the functions or output of one or more components of the alkalinity generation system 100 by sending instructions to, collecting data from, or monitoring operation of the one or more components. Additionally, the primary controller 106 may communicate information to a user of the alkalinity generation system 100, a servicer of the alkalinity generation system 100, or a person or company by sending notifications, alerts, or information to the interface 114.

In some instances, a lookup table of predetermined values, thresholds, ranges, and other information may be stored by the primary controller 106. Furthermore, the primary controller 106 may be in communication with a network, for example, a cloud network, and may be configured or designed to download one or more lookup tables. The primary controller 106 may select threshold values (e.g., a threshold alkalinity value) from the lookup table based on a number of factors, including, but not limited to, a determined pressure, flow rate, temperature, pH, alkalinity, and/or other parameters. In addition, the predetermined values, thresholds, ranges, and other information described with reference to any of the methods described herein may be manually implemented or otherwise input into the primary controller 106 by the interface 114.

Although FIG. 1 depicts the primary controller 106 in communication with the interface 114 and the chemical controller 102, it should be noted that various communication methodologies and connections may be implemented to work in conjunction with, or independent from, one or more local controllers associated with one or more individual components associated with the alkalinity generation system (e.g., a controller within the aquatic application 104 or a controller within the interface 114, etc.).

In some instances, machine learning (MVL), artificial intelligence (AI), or similar processes may be implemented to iteratively train the primary controller 106 or the chemical controller 102 and improve the performance of the alkalinity generation system 100 based on one or more feedback parameters, characteristics, or similar information. For example, in some instances, ML/AI may be used to predict an optimal interval for aquatic application testing intervals or pH/alkalinity threshold values. In some instances, ML/AI may be used to provide accurate water parameter testing and/or predict alkalinity value trends. Thus, the alkalinity generation system 100 may be optimized to efficiently test and dose the aquatic application 104 to control the alkalinity of the aquatic application 104.

In some instances, the chemical controller 102 can be coupled to one or more chemical distribution mechanisms 130. Each of the chemical distribution mechanisms 130 can individually be provided in the form of a pump, a vapor diffuser, an air stone, chemical feeders, or the like. The pump can be provided in the form of a peristaltic pump, a rotary pump, a reciprocating pump, a gear pump, a screw pump, a progressing cavity pump, a roots-type pump, a plunger pump, a triplex-style pump, a compressed-air-powered pump, a diaphragm pump, a rope pump, a flexible impeller pump, a hydraulic ram pump, a velocity pump, a gravity pump, a steam pump, or the like. The vapor diffuser can be provided in the form of a micro-bubble diffuser, a fine pore diffuser, a bubble diffuser, or a membrane diffuser. The air stone may be provided in the form of stone or domes comprising silica or aluminum oxide.

The chemical distribution mechanisms 130 may be in fluid communication with a plurality of chemical containers 140. Each of the plurality of chemical containers 140 may individually contain one or more water treatment chemicals. Thus, the chemical distribution mechanisms 130 can be designed to deliver the one or more water treatment chemicals to the aquatic application 104. In some instances, the chemical distribution mechanisms 130 may be separate from the chemical controller 102. In other instances, the chemical distribution mechanisms 130 may be integral to the chemical controller 102.

As depicted in FIG. 1, the system 100 may include one or more chemical distribution mechanisms 130. For example, the alkalinity generation system 100 of FIG. 1 comprises a first chemical distribution mechanism 131, a second chemical distribution mechanism 132, and a third chemical distribution mechanism 133. Further, the system 100 may include one or more chemical containers 140. In some instances, the system 100 may include a first chemical container 141, a second chemical container 142, and a third chemical container 143. The first, second, and third chemical containers 141, 142, 143 may be associated with the first, second, and third chemical distribution mechanisms 131, 132, 133, respectively. The first chemical container 141 may include a pH increaser 151 therein. The pH increaser 151 can be provided in the form of carbonate-based chemicals, such as potassium carbonate and sodium carbonate, or non-carbonate-based chemicals, such as potassium hydroxide. The second chemical container 142 may include an acid 152 therein, which in some instances is muriatic acid (i.e., hydrochloric acid provided in a diluted form). The third chemical container 143 may include an alkalinity modifier 153 therein, which in some instances is gaseous carbon dioxide. It is to be appreciated that the first, second, and third chemical distribution mechanisms 131, 132, 133 may utilize other pH adjusters and alkalinity adjusters than those explicitly recited herein.

Accordingly, the first chemical distribution mechanism 131 can be designed to control the dosage of the pH increaser 151 into the aquatic application 104. The second chemical distribution mechanism 132 can be designed to control the dosage of the acid 152 into the aquatic application 104. The third chemical distribution mechanism 133 can be designed to control the dosage of the alkalinity modifier 153 into the aquatic application 104. The third chemical distribution mechanism 133 can further include a valve 120 and an air stone 122 to bubble the gaseous carbon dioxide into the water of the aquatic application 104. It is to be appreciated that the air stone 122 may be in fluid communication with the water of the aquatic application 104. For example, the air stone 122 may be submerged, partially or fully, in the water of the aquatic application 104. As an additional example, the air stone 122 may be in fluid communication with a conduit through which water of the aquatic application 104 flows. As a further example, the air stone 122 may be in fluid communication with the recirculation system of the aquatic application 104. Thus, the air stone 122 may be designed to provide gaseous carbon dioxide to the water of the aquatic application 104.

Further, each of the primary controller 106 and the chemical controller 102 can be communicatively coupled to a first sensor 160. In some instances, the primary controller 106 and the secondary controller may be further communicatively coupled to a second sensor 170. The first sensor 160 and the second sensor 170 can each be designed to provide feedback regarding the status or water quality of the aquatic application 104 or any of the devices within the system 100. For example, the first sensor 160 and the second sensor 170 may be designed to measure, monitor, or sense one or more parameters of the water of the aquatic application 104. For instance, the first sensor 160 and the second sensor 170 can include one or more of a pH sensor, an alkalinity sensor, a temperature sensor, a flow rate sensor, a pressure sensor, or the like. In some instances, the first sensor 160 and the second sensor 170 may be provided in the form of the same type of sensor (e.g., both the first sensor 160 and the second sensor 170 are provided in the form of a pH sensor). In other instances, the first sensor 160 and the second sensor 170 may be provided in the form of different types of sensors (e.g., the first sensor 160 is provided in the form of a flow rate sensor and the second sensor 170 is provided in the form of a pH sensor). In addition, each of the first sensor 160 and the second sensor 170 may be fluidly coupled to or in fluid communication with the water of the aquatic application 104. For example, the first sensor 160 and the second sensor 170 may be immersed, either partially or fully, in the water of the aquatic application 104. As an additional example, the first sensor 160 and the second sensor 170 may be inserted into or in fluid communication with a conduit of the recirculation system of the aquatic application 104. As a further example, the first sensor 160 and the second sensor 170 may be positioned in-line or on-line with one or more conduits of the recirculation system of the aquatic application 104.

In some instances, the alkalinity sensor can be provided in the form of a colorimeter sensor. Conventionally, swimming pool water alkalinity can be measured with an at-home color test strip kit. However, color test strip kits require a user to manually test the water, upload the test data, and/or manually adjust one or more water treatment chemical dosage rates. Moreover, manual color test strip kits can be difficult to use because a user may misread the test, the user may not enter the test data into the controller, or the user may not know how to adjust the water treatment chemical dosage rates based on the test data. Thus, it can be beneficial to automate the process for determining the alkalinity of the water in the system 100 through the use of a colorimeter sensor.

Therefore, in instances where the first sensor 160 and/or the second sensor 170 may be provided in the form of an alkalinity sensor, the alkalinity sensor may be provided in the form of a colorimeter. The colorimeter may be designed to detect one or more water quality parameters, such as alkalinity. The colorimeter can be made and operated according to the disclosure of U.S. patent application Ser. No. 18/994,732, filed Jan. 15, 2025, the contents of which are hereby incorporated by reference in its entirety. In particular, in some instances, the colorimeter can include an inlet (not depicted) designed to deliver a water sample from the aquatic application 104 to a photometric analyzer, a chemical reagent system downstream of the inlet and upstream of the photometric analyzer, and a controller. In some instances, the controller can be the primary controller 106 and/or the chemical controller 102.

The chemical reagent system may be designed to inject one or more reagents into the water sample. The photometric analyzer may comprise a vial designed to contain the water sample, at least one light source designed to emit light toward a first side of the vial, and at least one light detector designed to detect the emitted light on a second side of the vial. The controller can be configured to adjust a dosage of the one or more reagents injected into the water sample, receive data from the at least one light detector, and analyze the water quality of the water sample based on the received data.

In various cases, the first sensor 160 and/or the second sensor 170 may be provided in the form of any sensor designed to measure one or more physical or chemical parameters of the aquatic application 104. For example, the first sensor 160 and/or the second sensor 170 may be provided in the form of a pH sensor, an ORP sensor, a free chlorine sensor, a total chlorine sensor, a TDS probe, a salt sensor, a cyanuric acid sensor, a temperature sensor, a water level sensor, a flow sensor, a pressure sensor, a turbidity sensor, a colorimeter, and the like. As such, the first sensor 160 and/or the second sensor 170 may be selected from the group consisting of a pH sensor, an ORP sensor, a free chlorine sensor, a total chlorine sensor, a TDS probe, a salt sensor, a cyanuric acid sensor, a temperature sensor, a water level sensor, a flow sensor, a pressure sensor, a turbidity sensor, a colorimeter, or combinations thereof.

The primary controller 106 and/or the chemical controller 102 can be designed to independently control each of the one or more chemical distribution mechanisms 130 based on information from the first sensor 160 and/or the second sensor 170.

In some instances, the primary controller 106 may be communicatively coupled to and control the operation of the chemical controller 102. For example, the primary controller 106 may exercise a high level of control over the operation of the chemical controller 102. In such instances, the primary controller 106 may be configured or designed to send a signal to the chemical controller 102 indicating that the chemical controller 102 should operate without input from the primary controller 106. As an additional example, the primary controller 106 may exercise a precise level of control over the operation of the chemical controller 102. In such instances, the primary controller 106 may send a signal to the chemical controller 102 directing the chemical controller 102 to deposit a specific volume (e.g., 100 mL) of a specific chemical (e.g., the pH increaser 151) into the aquatic application 104. In other instances, the primary controller 106 and the chemical controller 102 can share controlling responsibilities. For example, during normal conditions, the primary controller 106 can communicate to the chemical controller 102 one or more time periods during which it may operate. When the primary controller 106 communicates one or more time periods during which the chemical controller 102 may operate, the primary controller 106 may indicate specific operations or may indicate that the chemical controller 102 may operate as needed. However, if the primary controller 106 determines that a chemical condition of the aquatic application 104 requires attention (e.g., pH value is outside of an acceptable range, etc.), the chemical controller 102 can send a signal to the primary controller 106 indicating the chemical condition. The primary controller 106 can then cease or affect operation of various devices according to the needs of the chemical controller 102.

In other instances, the chemical controller 102 can operate as a standalone device or as a device that operates relatively (or completely) independently from the primary controller 106. For example, the chemical controller 102 may only report information to the primary controller 106. In some approaches, the automation and/or programming of the chemical controller 102 may have a limited amount of settings that can be altered. For example, in certain configurations, the chemical controller 102 may induce a feed (i.e., introduce chemicals into the aquatic application 104) by adjusting the chemical set point.

Additionally, in some instances, the chemical controller 102 can operate in conjunction with controllers associated with other system devices (e.g., a local controller). For example, in some instances, the chemical controller 102 can be designed to control the heater 112, to monitor pump flow rates, and to perform other functions and controls described above with respect to the primary controller 106.

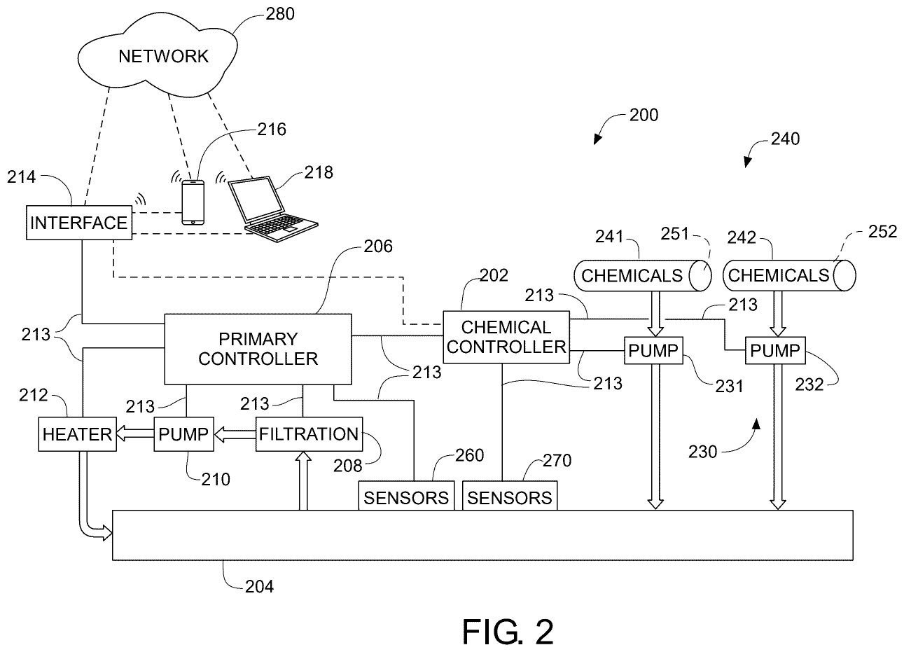

Turning to FIG. 2, an alkalinity generation system 200 for monitoring water quality and controlling the dosage rate of a plurality of water treatment chemicals is illustrated. The alkalinity generation system 200 may be similar to the alkalinity generation system 100 of FIG. 1, except that the alkalinity generation system 200 may omit the introduction of gaseous carbon dioxide to an aquatic application. Thus, components having similar names or numbering in the alkalinity generation system 200 as compared to the components of the alkalinity generation system 100 of FIG. 1 may be imparted with similar structures and/or functions as such like-named or numbered components of the alkalinity generation system 100.

Referring again to FIG. 2, the alkalinity generation system 200 may include a chemical controller 202. The chemical controller 202 may be generally used in conjunction with one or more aquatic applications (e.g., an aquatic application 204), for example, a pool, a hot tub, a spa tub, a fountain, or any other fluid application where regulation of one or more chemicals may be beneficial. The one or more aquatic applications 204 may be provided with a volume of water. The volume of water may be imparted with a pH value and an alkalinity level. The chemical controller 202 can be communicatively coupled to a primary controller 206 that communicates with or otherwise operates other devices designed to control various aspects of the aquatic application 204. For example, the primary controller 206 can be communicatively coupled with and/or designed to control one or more of a filtration device 208, a pump 210, a heater 212, and/or any number of other devices and systems used with the aquatic application 204. The chemical controller 202 may be in electronic communication with the primary controller 206 and the pump via a plurality of control connections 213. The primary controller 206 may be in electronic communication with the filtration device 208, the pump 210, and the heater 212 via one of the plurality of control connections 213. It is to be understood that the plurality of control connections 213 may be wired or wireless electronic communication pathways.

The primary controller 206 can include an integral or separate control interface 214 to enable control of the system by a user and/or to provide data (e.g., status, temperatures, settings, levels, etc.) to the user. The primary controller 206 may be provided in the form of the IntelliChem® Water Chemistry Controller. The primary controller 206 may be pre-operated or controlled in accordance with U.S. patent application Ser. No. 18/342,675, which is incorporated herein by reference. In some instances, the control interface 214 can also communicate directly with the chemical controller 202. In other instances, the chemical controller 202 can communicate with the primary controller 206 instead. For example, the chemical controller 202 can be designed to relay instructions to the plurality of system devices through the primary controller 206 or from the interface 214.

Still referring to FIG. 2, the primary controller 206 and the interface 214 may interface either directly over a network 280, for example, a local area network or a cloud network. The primary controller 206 may be a gateway, a hub, a switch, a router, a server, or other connection device to allow integration, monitoring, and control of multiple aspects of the alkalinity generation system 200. In some instances, the primary controller 206 may be part of a control system comprising a processor, memory, output/input device, and power supply. In some instances, the primary controller 206 may be located external to the alkalinity generation system 200 and may be connected via Bluetooth, WiFi, internet, remote control, a wired connection, and/or other similar communication technologies.

The interface 214 can be provided in the form of a touch-screen interface that a user can interact with to control the alkalinity generation system 200. In some instances, the interface 214 may be capable of providing, communicating with, or being incorporated into other user interfaces via other user devices, such as a smartphone 216, a computer 218, a tablet device (not shown), or other user devices. Such communication may be effected through one or more wired connections or via a wireless connection, either directly to the primary controller 206 or through one or more remote servers providing an online control service. In some instances, communication may similarly be affected between the user devices (e.g., the smartphone 216 or the computer 218) and the chemical controller 202.

The primary controller 206 may be configured or designed to control the functions or output of one or more components of the alkalinity generation system 200 by sending instructions to, collecting data from, or monitoring operation of the one or more components. Additionally, the primary controller 206 may communicate information to a user of the alkalinity generation system 200, a servicer of the alkalinity generation system 200, or a person or company by sending notifications, alerts, or information to the interface 214.

In some instances, a lookup table of predetermined values, thresholds, ranges, and other information may be stored by the primary controller 206. Furthermore, the primary controller 206 may be in communication with a network 280, for example, a cloud network, and may be configured or designed to download one or more lookup tables. The primary controller 206 may select threshold values (e.g., a threshold alkalinity value) from the lookup table based on a number of factors, including, but not limited to, a determined pressure, flow rate, temperature, pH, alkalinity, and/or other parameters. In addition, the predetermined values, thresholds, ranges, and other information described with reference to any of the methods described herein may be manually implemented or otherwise input into the primary controller 206 by the interface 214.

Although FIG. 2 depicts the primary controller 206 in communication with the interface 214 and the chemical controller 202, it should be noted that various communication methodologies and connections may be implemented to work in conjunction with, or independent from, one or more local controllers associated with one or more individual components associated with the alkalinity generation system (e.g., a controller within the aquatic application 204 or a controller within the interface 214, etc.).

In some instances, machine learning (ML), artificial intelligence (AI), or similar processes may be implemented to iteratively train the primary controller 206 or the chemical controller 202 and improve the performance of the alkalinity generation system 200 based on one or more feedback parameters, characteristics, or similar information. For example, in some instances, ML/AI may be used to predict an optimal interval for aquatic application testing intervals or pH/alkalinity threshold values. In some instances, ML/AI may be used to provide accurate water parameter testing and/or predict alkalinity value trends. Thus, the alkalinity generation system 200 may be optimized to efficiently test and dose the aquatic application 204 to control the alkalinity of the aquatic application 204.

In some instances, the chemical controller 202 can be coupled to one or more chemical distribution mechanisms 230. Each of the chemical distribution mechanisms 230 can individually be provided in the form of a pump, a vapor diffuser, an air stone, chemical feeders, or the like. The pump can be provided in the form of a peristaltic pump, a rotary pump, a reciprocating pump, a gear pump, a screw pump, a progressing cavity pump, a roots-type pump, a plunger pump, a triplex-style pump, a compressed-air-powered pump, a diaphragm pump, a rope pump, a flexible impeller pump, a hydraulic ram pump, a velocity pump, a gravity pump, a steam pump, or the like. The vapor diffuser can be provided in the form of a micro-bubble diffuser, a fine-pore diffuser, a bubble diffuser, or a membrane diffuser. The air stone may be provided in the form of stones or domes comprising silica or aluminum oxide.

The chemical distribution mechanisms 230 may be in fluid communication with a plurality of chemical containers 240. Each of the plurality of chemical containers 240 may individually contain one or more water treatment chemicals. Thus, the chemical distribution mechanisms 230 can be designed to deliver the one or more water treatment chemicals to the aquatic application 204. In some instances, the chemical distribution mechanisms 230 may be separate from the chemical controller 202. In other instances, the chemical distribution mechanisms 230 may be integral to the chemical controller 202.

As depicted in FIG. 2, the system 200 may include one or more chemical distribution mechanisms 230. For example, the alkalinity generation system 200 of FIG. 2 comprises a first chemical distribution mechanism 231 and a second chemical distribution mechanism 232. Further, the system 200 may include one or more chemical containers 240. In some instances, the system 200 may include a first chemical container 241 and a second chemical container 242. The first and second chemical containers 241, 242 may be associated with the first and second chemical distribution mechanisms 231, 232, respectively. The first chemical container 241 may include a pH increaser 251 therein. The pH increaser 251 can be provided in the form of carbonate-based chemicals, such as potassium carbonate and sodium carbonate. The second chemical container 242 may include an acid 252 therein, which in some instances is muriatic acid (i.e., hydrochloric acid provided in a diluted form). In the alkalinity generation system 200, as compared to the alkalinity generation system 100 of FIG. 1, only the pH increaser 251 may contribute to changing the alkalinity value of the aquatic application 204.

Accordingly, and referring again to FIG. 2, the first chemical distribution mechanism 231 can be designed to control the dosage of the pH increaser 251 into the aquatic application 204. The second chemical distribution mechanism 232 can be designed to control the dosage of the acid 252 into the aquatic application 204.

Further, each of the primary controller 206 and the chemical controller 202 can be communicatively coupled to a first sensor 260 via one of the plurality of control connections 213. In some instances, the primary controller 206 and the chemical controller 202 may be further communicatively coupled to a second sensor 270. The first sensor 260 and the second sensor 270 can each be designed to provide feedback regarding the status or water quality of the aquatic application 204 or any of the devices within the system 200. For example, the first sensor 260 and the second sensor 270 may be designed to measure, monitor, or sense one or more parameters of the water of the aquatic application 204. For instance, the first sensor 260 and the second sensor 270 can include one or more of a pH sensor, an alkalinity sensor, a temperature sensor, a flow rate sensor, a pressure sensor, or the like. In some instances, the first sensor 260 and the second sensor 270 may be provided in the form of the same type of sensor (e.g., both the first sensor 260 and the second sensor 270 are provided in the form of a pH sensor). In other instances, the first sensor 260 and the second sensor 270 may be provided in the form of different types of sensors (e.g., the first sensor 260 is provided in the form of a flow rate sensor and the second sensor 270 is provided in the form of a pH sensor). In addition, each of the first sensor 260 and the second sensor 270 may be fluidly coupled to or in fluid communication with the water of the aquatic application 204. For example, the first sensor 260 and the second sensor 270 may be immersed, either partially or fully, in the water of the aquatic application 204. As an additional example, the first sensor 260 and the second sensor 270 may be inserted into or in fluid communication with a conduit of the recirculation system of the aquatic application 204. As a further example, the first sensor 260 and the second sensor 270 may be positioned in-line or on-line with one or more conduits of the recirculation system of the aquatic application 204.

In some instances, the alkalinity sensor can be provided in the form of a colorimeter sensor. Therefore, in instances where the first sensor 260 and/or the second sensor 270 may be provided in the form of an alkalinity sensor, the alkalinity sensor may be provided in the form of a colorimeter. The colorimeter may be designed to detect one or more water quality parameters, such as alkalinity. The colorimeter can be made and operated according to the disclosure of U.S. patent application Ser. No. 18/994,732, filed Jan. 15, 2025, the contents of which are hereby incorporated by reference in its entirety. In particular, in some instances, the colorimeter can include an inlet (not depicted) designed to deliver a water sample from the aquatic application 204 to a photometric analyzer, a chemical reagent system downstream of the inlet and upstream of the photometric analyzer, and a controller. In some instances, the controller can be the primary controller 206 and/or the chemical controller 202.

The chemical reagent system may be designed to inject one or more reagents into the water sample. The photometric analyzer may comprise a vial designed to contain the water sample, at least one light source designed to emit light toward a first side of the vial, and at least one light detector designed to detect the emitted light on a second side of the vial. The controller can be configured to adjust a dosage of the one or more reagents injected into the water sample, receive data from the at least one light detector, and analyze the water quality of the water sample based on the received data.

In various cases, the first sensor 260 and/or the second sensor 270 may be provided in the form of any sensor designed to measure one or more physical or chemical parameters of the aquatic application 204. For example, the first sensor 260 and/or the second sensor 270 may be provided in the form of a pH sensor, an ORP sensor, a free chlorine sensor, a total chlorine sensor, a TDS probe, a salt sensor, a cyanuric acid sensor, a temperature sensor, a water level sensor, a flow sensor, a pressure sensor, a turbidity sensor, a colorimeter, and the like. As such, the first sensor 260 and/or the second sensor 270 may be selected from the group consisting of a pH sensor, an ORP sensor, a free chlorine sensor, a total chlorine sensor, a TDS probe, a salt sensor, a cyanuric acid sensor, a temperature sensor, a water level sensor, a flow sensor, a pressure sensor, a turbidity sensor, a colorimeter, or combinations thereof.

The primary controller 206 and/or the chemical controller 202 can be designed to independently control each of the one or more chemical distribution mechanisms 230 based on information from the first sensor 260 and/or the second sensor 270.

In some instances, the primary controller 206 may be communicatively coupled to and control the operation of the chemical controller 202 via one of the plurality of control connections 213. For example, the primary controller 206 may exercise a high level of control over the operation of the chemical controller 202. In such instances, the primary controller 206 may be configured or designed to send a signal to the chemical controller 202 indicating that the chemical controller 202 should operate without input from the primary controller 206. As an additional example, the primary controller 206 may exercise a precise level of control over the operation of the chemical controller 202. In such instances, the primary controller 206 may send a signal to the chemical controller 202 directing the chemical controller 202 to deposit a specific volume (e.g., 100 mL) of a specific chemical (e.g., the pH increaser 251) into the aquatic application 204. In other instances, the primary controller 206 and the chemical controller 202 can share controlling responsibilities. For example, during normal conditions, the primary controller 206 can communicate to the chemical controller 202 one or more time periods during which it may operate. When the primary controller 206 communicates one or more time periods during which the chemical controller 202 may operate, the primary controller 206 may indicate specific operations or may indicate that the chemical controller 202 may operate as needed. However, if the primary controller 206 determines that a chemical condition of the aquatic application 204 requires attention (e.g., pH value is outside of an acceptable range, etc.), the chemical controller 202 can send a signal to the primary controller 206 indicating the chemical condition. The primary controller 206 can then cease or affect operation of various devices according to the needs of the chemical controller 202.

In other instances, the chemical controller 202 can operate as a standalone device or as a device that operates relatively (or completely) independently from the primary controller 206. For example, the chemical controller 202 may only report information to the primary controller 206. In some approaches, the automation and/or programming of the chemical controller 202 may have a limited amount of settings that can be altered. For example, in certain configurations, the chemical controller 202 may induce a feed (i.e., introduce chemicals into the aquatic application 204) by adjusting the chemical set point.

Additionally, in some instances, the chemical controller 202 can operate in conjunction with controllers associated with other system devices (e.g., a local controller). For example, in some instances, the chemical controller 202 can be designed to control the heater 212, to monitor pump flow rates, and to perform other functions and controls described above with respect to the primary controller 206.

Thus, the alkalinity generation system 200 may control the alkalinity level and pH of the aquatic application 204 by automatically dosing the aquatic application with the pH increaser 251, the acid 252, or both the pH increaser 251 and the acid 252 in response to a measured pH value or a measured alkalinity level of the aquatic application 204.

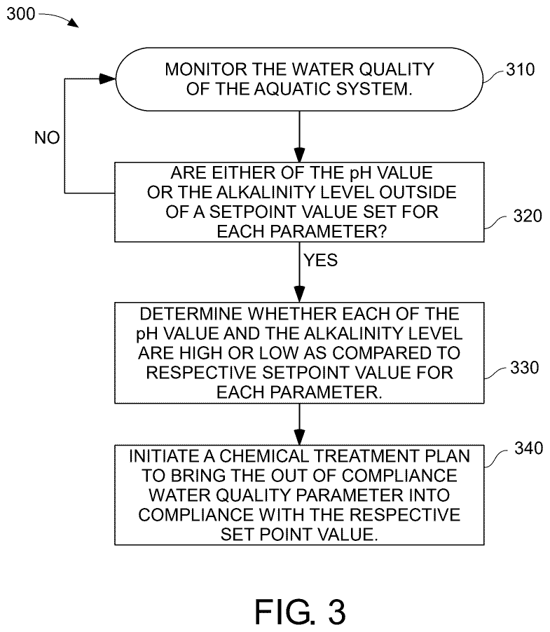

Turning now to FIG. 3, a method 300 for monitoring and initiating a chemical treatment plan via the alkalinity generation system 100 of FIG. 1 or the alkalinity generation system 200 of FIG. 2 is illustrated. The method 300 may be designed to adjust a measured alkalinity level of an aquatic application (such as the aquatic application 104 of FIG. 1 or the aquatic application 204 of FIG. 2).

At 310, the method 300 may include monitoring the water quality of an aquatic system. The water quality of the aquatic system may be monitored by one or more sensors, such as the first sensor 160 and/or the second sensor 170 of FIG. 1 or the first sensor 260 and/or the second sensor 270 of FIG. 2. The one or more sensors can be designed to detect, measure, monitor, or sense one or more water quality parameters, including a pH value and/or alkalinity levels. The one or more sensors may provide the one or more detected parameters to a controller (such as the primary controller 106 or the chemical controller 102 of FIG. 1 or the primary controller 206 or the chemical controller 202 of FIG. 2). The controller can be designed to monitor the pH value and alkalinity level of the water in the aquatic application 104 based on the one or more water parameters detected and received from the one or more sensors.

At 320, the controller may analyze the one or more parameters received by the one or more sensors to determine if the one or more parameters are outside of a target parameter value. For example, the controller may determine if the pH value and/or the alkalinity value detected by the one or more sensors are outside of a target pH value or a target alkalinity value. In such instances, the target pH value may be determined by the controller. The target pH value may be imparted with a value of at least about 7.2 to about at least 7.8 (or at least 7.2 to at least 7.8). For example, the target pH value may be imparted with a value of at least about 7.2, or at least about 7.3, or at least about 7.4, or at least about 7.5, or at least about 7.6, or at least about 7.7, or at least about 7.8. In certain other instances, the target pH value may be imparted with a value of about 7.2, or about 7.3, or about 7.4, or about 7.5, or about 7.6, or about 7.7, or about 7.8. As an additional example, the target pH value may be imparted with a value of at least 7.2, or at least 7.3, or at least 7.4, or at least 7.5, or at least 7.6, or at least 7.7, or at least 7.8. In certain other instances, the target pH value may be imparted with a value of 7.2, or 7.3, or 7.4, or 7.5, or 7.6, or 7.7, or 7.8.

In some instances, a target pH range for the water of the aquatic application may be about 7.2 to about 7.8, or about 7.3 to about 7.7, or about 7.4 to about 7.5. In other instances, the target pH range for the water of the aquatic application may be 7.2 to 7.8, or 7.3 to 7.7, or 7.4 to 7.5.

The controller may also determine the target alkalinity value. The target alkalinity value may be imparted with a value of at least about 80 ppm to at least about 120 ppm (or at least 80 ppm to at least 120 ppm). For example, the target alkalinity value may be imparted with a value of at least about 80 ppm, or at least about 90 ppm, or at least about 100 ppm, or at least about 110 ppm, or at least about 120 ppm. In certain other instances, the target alkalinity value may be imparted with a value of about 80 ppm, or about 90 ppm, or about 100 ppm, or about 110 ppm, or about 120 ppm. As an additional example, the target alkalinity value may be imparted with a value of at least 80 ppm, or at least 90 ppm, or at least 100 ppm, or at least 110 ppm, or at least 120 ppm. In certain other instances, the target alkalinity value may be imparted with a value of 80 ppm, or 90 ppm, or 100 ppm, or 110 ppm, or 120 ppm.

In some instances, a target alkalinity range for the water of the aquatic application may be about 75 ppm to about 150 ppm, or about 80 ppm to about 120 ppm, or about 90 ppm to about 110 ppm. In other instances, the target alkalinity range for the water of the aquatic application may be 75 ppm to 150 ppm, or 80 ppm to 120 ppm, or 90 ppm to 110 ppm.

It is to be understood that the target pH value and the target alkalinity value may be imparted with a value between the minimum and maximum values described herein. It is also to be understood that the target pH value and the target alkalinity value may be imparted with a value greater than or less than the minimum and maximum values described herein.

Still referring to 320, if the controller determines that the pH value or the alkalinity value are at the target pH value or the target alkalinity value, the method 300 may proceed back to 310 and the controller may continue to monitor the pH value or the alkalinity value. If the controller determines that the pH value or the alkalinity value are outside the target pH value or the target alkalinity value, the method 300 may proceed to 330.

At 330, the controller may determine if the measured water quality parameter (e.g., the pH value and/or the alkalinity value) is greater than or less than the target water quality parameter value. For example, if, at 320, the controller determines that the pH value is outside the target pH value, the controller may then determine if the measured pH value is greater than or less than the target pH value. As an additional example, if, at 320, the controller determines the alkalinity value is outside the target alkalinity value, the controller may then determine if the measured alkalinity value is greater than or less than the target alkalinity value.

At 340, using the determination made at 330, the controller may initiate a chemical treatment plan in an aquatic application (such as the aquatic application 104 of FIG. 1 or the aquatic application 204 of FIG. 2).

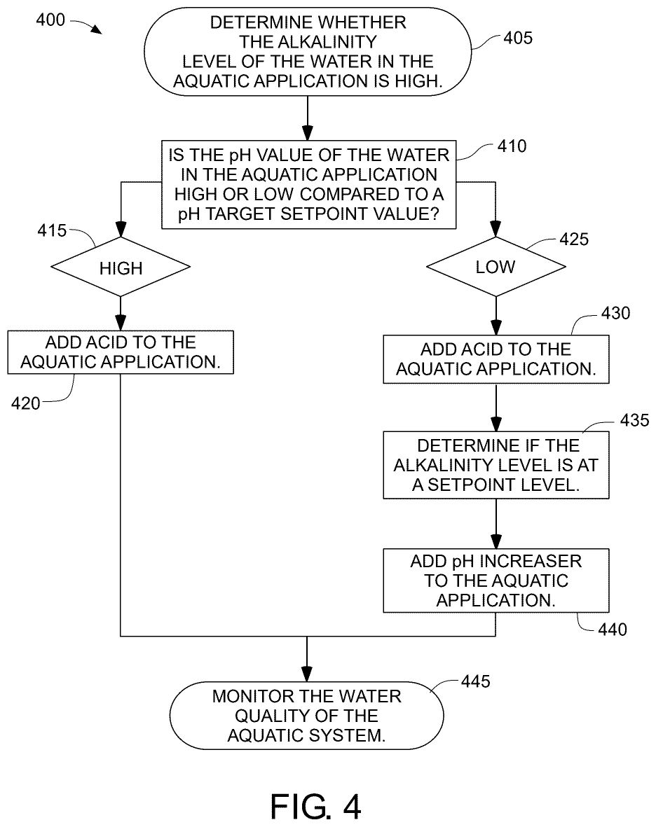

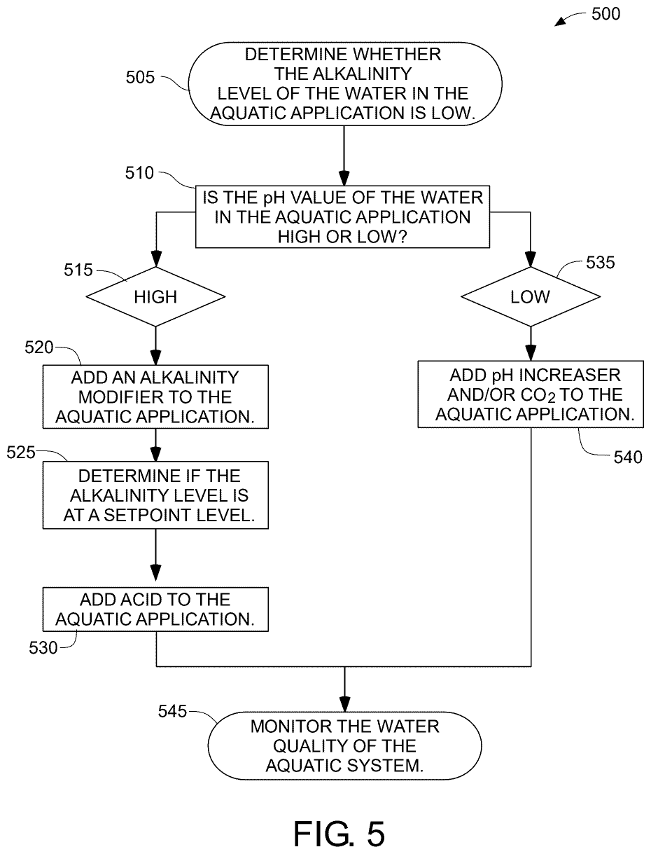

Accordingly, FIGS. 4 and 5 illustrate methods for implementing a chemical treatment plan based on whether the pH value and/or alkalinity level are high or low. As discussed above, the alkalinity generation system 100 of FIG. 1 includes the pH increaser 151, the acid 152, and the alkalinity modifier 153, and the alkalinity generation system 200 of FIG. 2 includes the pH increaser 251 and the acid 252. Further, the alkalinity modifier 153 can be gaseous carbon dioxide (CO₂). Carbon dioxide can influence the pH value of the aquatic application 104 by reacting with the water in the aquatic application 104 to form carbonic acid (H₂CO₃), which can dissociate to form a hydrogen ion (H⁺) and a hydrogen carbonate ion (HCO₃⁻, also referred to as bicarbonate). The hydrogen ions may lower the pH value and the bicarbonate ions accumulate in the water, creating a pH buffer provided in the form of the carbonate system. The carbonate system can be described by Formula I.

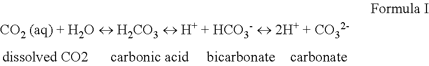

The carbonate system is made up of dissolved carbon dioxide and all of its related species. The carbon dioxide combines with water and then gives up or accepts hydrogen ions depending on the pH value. Bicarbonate molecules are used to neutralize acids by accepting a hydrogen ion from an acid and becoming carbonic acid. The carbonic acid left from this reaction then slowly leaves the aquatic application 104 by evaporating out of the water as carbon dioxide. However, through the addition of bases, carbonic acid can be converted to bicarbonate. Additionally, bicarbonate can be converted further into carbonate.

Moreover, the equilibrium levels of each of the above species in Formula I are pH-dependent. Any of the species in the carbonate system can be converted to the other species by adding and removing hydrogen through the use of acids and bases. Therefore, adding carbon dioxide to the water of the aquatic application 104 can affect the pH value and the alkalinity level in the aquatic application 104. Thus, each of the methods discussed in FIGS. 4 and 5 illustrates how the carbonate system described above can be utilized to adjust the pH value and/or the alkalinity level in the aquatic application 104.

Turning to FIG. 4, a method for lowering an alkalinity level in a volume of water in an aquatic application (such as the aquatic application 104 of FIG. 1 or the aquatic application 204 of FIG. 2), a method 400, is provided. In some instances, the method 400 may occur after a controller (such as the primary controller 106 of FIG. 1 or the primary controller 206 of FIG. 2) has determined that the alkalinity level of the volume of water in the aquatic application is high (such as in step 330 of method 300 of FIG. 3). Thus, the method 400 may be implemented as step 340 of method 300 of FIG. 3. As mentioned above, it can be beneficial to maintain the alkalinity within a desired range or at a target value so that the volume of water can resist pH value fluctuations. In some instances, the pH value of the volume of water may change due to changes in the acid concentration in the water. However, if the alkalinity level is too high, controlling the pH value in the volume of water may be difficult because a volume of water with a high alkalinity level can become resistant to desired pH changes. In other instances, other steps may be implemented to lower the alkalinity level in the volume of water.

At 405, the method 400 may include a controller (such as the primary controller 106 of FIG. 1 or the primary controller 206 of FIG. 2) determining that the alkalinity level of the aquatic application 104, 204 is high (e.g., above a set point, a target value, or above an upper limit of a range).

At 410, the method 400 may include the controller (primary controller 106, 206 or chemical controller 102, 202) determining if the pH value of the aquatic application 104, 204 is greater than a pH target setpoint value. For example, the pH target setpoint value may be imparted with the value of 7.3. The controller may receive a measured pH value of the aquatic application 104, 204 from a sensor (such as the first sensor 160 and second sensor 170 of FIG. 1 or the first sensor 260 and second sensor 270 of FIG. 2). The controller may then determine if the measured pH value is higher than the pH target setpoint value of 7.3. If the controller determines that the pH value of the aquatic application 104, 204 is greater than the pH target setpoint value, the method 400 proceeds to 415. If the controller determines that the pH value of the aquatic application 104, 204 is less than the pH target setpoint value, the method proceeds to 425.

At 415, the method 400 may include the controller determining the pH value is higher than the pH target setpoint value. For example, if the pH target setpoint value is 7.3 and the pH value of the aquatic application 104, 204 is 7.6, the controller will determine the pH value of the aquatic application 104, 204 is greater than that of the pH target setpoint value, and the method 400 will proceed to 420. Once the controller determines the pH value is higher than the pH target setpoint value, the method 400 proceeds to 420.

At 420, the method 400 may include initiating a first chemical treatment plan designed to lower the pH value and the alkalinity level of the aquatic application 104, 204. In some instances, at 420, the controller may instruct the second chemical distribution mechanism 132 of FIG. 1 or the second chemical distribution mechanism 232 of FIG. 2 to add acid 152, 252, respectively, to the aquatic application 104, 204. The acid 152, 252 may be designed to lower the pH value of the aquatic application 104, 204 without increasing the alkalinity level. For example, when the acid 152, 252 is added to the aquatic application 104, 204, the acid may react with the alkaline substances in the aquatic application 104, 204 (e.g., bicarbonate molecules) to neutralize the alkaline substances and reduce the concentration of the alkaline substances. The neutralization process may decrease the ability of the aquatic application 104, 204 to resist changes in pH, leading to a decrease in alkalinity. Conversely, carbon dioxide can lower the pH value and simultaneously increase the alkalinity level. Thus, it can be counterproductive to lower the pH value with carbon dioxide when the alkalinity level is also high. Accordingly, the acid 152, 252 can be used to lower both the pH value and the alkalinity level in the aquatic application 104, 204.

At 425, the method 400 may include the controller determining the pH level is lower than the pH target setpoint value. For example, if the pH target setpoint value is 7.3 and the pH value of the aquatic application 104, 204 is 7.2, the controller will determine the pH value of the aquatic application 104, 204 is less than that of the pH target setpoint value. Once the controller determines the pH value is less than the pH target setpoint value, the method 400 proceeds to 430.

At 430, the method 400 may include the controller initiating a second chemical treatment plan designed to lower the pH level of the aquatic application 104, 204. Upon initiation of the second chemical treatment plan, the controller may instruct the second chemical distribution mechanism 132 of FIG. 1 or the second chemical distribution mechanism 232 of FIG. 2 to direct acid 152, 252 into the aquatic application 104, 204. As noted above, controlling the pH level of the aquatic application 104, 204 may be difficult when the alkalinity level is outside the target alkalinity level. Thus, even though adding acid may further lower the pH level of the aquatic application 104, 204, the lower pH will also lower the alkalinity level of the aquatic application 104, 204.

At 435, the method may include the controller monitoring the alkalinity level of the aquatic application 104, 204 and determining when the alkalinity level has reached the alkalinity target setpoint value. The controller may receive one or more measurements of the alkalinity level in the aquatic application 104, 204 from one or more sensors (such as the one or more sensors 160, 170 of FIG. 1 or sensors 260, 270 of FIG. 2) and determine if the measured alkalinity level is at the alkalinity target setpoint value. Once the controller determines the alkalinity level has reached the alkalinity target setpoint value, the controller can instruct the first chemical distribution mechanism (such as the second chemical distribution mechanism 132 of FIG. 1 or the second chemical distribution mechanism 232 of FIG. 2) to stop adding the acid (such as the acid 152 of FIG. 1 or the acid 252 of FIG. 2) to the aquatic application 104, 204.

At 440, the method 400 may include the controller determining the pH value of the aquatic application 104, 204. Once the controller determines the pH value of the aquatic application 104, 204, the controller may instruct the first chemical distribution mechanism 131 of FIG. 1 or the first chemical distribution mechanism 231 of FIG. 2 to add a pH increaser (such as the pH increaser 151 of FIG. 1 or the pH increaser 251 of FIG. 2) to the aquatic application 104, 204 to raise the pH value of the aquatic application 104, 204. In various cases, the pH increaser may be added to the aquatic application 104, 204 to bring the pH value back to a target pH range. After the pH increaser is added to the aquatic application 104, 204, the method 400 may proceed to 445. At 445, the method may include the controller monitoring the aquatic application 104, 204, including monitoring one or more water parameters (e.g., the pH value and the alkalinity level). The controller may determine, based on the one or more parameters, if further corrective action is needed. Thus, in some instances, after the method 400 is completed, the controller can be designed to return to 310 of the method 300 of FIG. 3.

Now turning to FIG. 5, a method 500 for raising the alkalinity level in the aquatic application 104 after a controller has determined that the alkalinity level is low (e.g., step 330 of FIG. 3) is illustrated. In some instances, the method 500 can be implemented after or as part of 340 of method 300 of FIG. 3.

At 505, the method 500 may include a controller (e.g., the primary controller 106 and/or the chemical controller 102) determining that the alkalinity level of the volume of water is less than an alkalinity target setpoint value. As mentioned above, it can be beneficial to maintain the alkalinity level of the volume of water within a desired range so that the aquatic application 104 can resist pH value fluctuations. pH fluctuations may be due to changes in the acid concentration in the aquatic application 104. Therefore, if the alkalinity level is low, it can be difficult to control the pH value in the aquatic application 104 because the pH value can be more susceptible to fluctuations with changing acid concentrations in the aquatic application (i.e., the water's pH value becomes volatile). Additionally, the pH level of the aquatic application 104 may affect how the alkalinity level of the aquatic application 104 can be raised.

At 510, the method 500 may include the controller determining if the pH value of the aquatic application 104 is greater than or less than a pH target setpoint value. If the controller determines the pH value is greater than the pH setpoint value, the method 500 proceeds to 515. If the controller determines the pH value is less than the pH setpoint value, the method proceeds to 535.

At 515, the method 500 may include the controller determining whether the pH value is higher than the pH setpoint value. The controller may then initiate a chemical treatment plan, where the chemical treatment plan may be designed to raise the alkalinity level and lower the pH value. The method 500 may then proceed to 520.

At 520, the method may include the controller instructing the third chemical distribution mechanism 133 of FIG. 1 to add the alkalinity modifier 153 to the aquatic application 104. As mentioned above, in some instances, the alkalinity modifier 153 may be carbon dioxide, and based on the carbonate system of Formula I, carbon dioxide can raise the alkalinity level. However, carbon dioxide can also lower the pH value of the water. The method 500 then proceeds to 525.

At 525, the method 500 may include the controller monitoring the alkalinity level of the aquatic application 104 and determining when the alkalinity level has reached the alkalinity target setpoint. Once the alkalinity level has reached the alkalinity target setpoint, the controller may instruct the third chemical distribution mechanism 133 of FIG. 1 to stop adding the alkalinity modifier 153 to the aquatic application 104. The method 500 then proceeds to 530.

At 530, the method 500 may include the controller determining the pH value of the aquatic application 104 and instructing the second chemical distribution mechanism 132 of FIG. 1 to add the acid 152 of FIG. 1 to the aquatic application 104 to lower the pH value of the aquatic application 104. The method then proceeds to 545.

At 535, the method 500 may include the controller determining that the pH value of the aquatic application 104 is less than the pH target setpoint value. The controller may then initiate a second chemical treatment plan to raise both the pH value and the alkalinity value. The method 500 then proceeds to 540.

At 540, the method 500 may include the implementation of the second chemical treatment plan by the controller. The controller may instruct the first chemical distribution mechanism 131 of FIG. 1 to add the pH increaser 151 of FIG. 1 and/or the third chemical distribution mechanism 133 of FIG. 1 to add the alkalinity modifier 153 to the aquatic application 104. Together, the pH increaser 151 and the alkalinity modifier 153 may raise the alkalinity level of the aquatic application 104. Thus, depending on the difference between the alkalinity level of the aquatic application 104 and the alkalinity target setpoint value and the difference between the pH value and the pH target setpoint value, one of or both of the pH increaser 151 and the alkalinity modifier 153 may be added to the aquatic application 104 at 540. The method then proceeds to 545.

After 545, the controller may monitor one or more parameters (e.g., the pH value and the alkalinity level) of the aquatic application 104 to determine if further corrective action is needed. Thus, after the method 500 is completed, the controller can be designed to return to 310 of the method 300 of FIG. 3.

It is to be understood that any of the steps of the method 300, the method 400, or the method 500 may be repeated, omitted, or performed in alternative orders. In addition, the method 300, the method 400, or the method 500 may be implemented together (e.g., the steps of the methods 400, 500 may be carried out after the method 300) or independently of each other. Furthermore, the method 300, the method 400, or the method 500 may be implemented by one or more components of the alkalinity generation systems 100, 200, and variations thereof, discussed herein.

Accordingly, as discussed above, the pH value and alkalinity level in the aquatic application 104 can be controlled using the pH increaser 151, the acid 152, and the alkalinity modifier 153. Further, the pH and alkalinity control can be automated because the alkalinity modifier 153 can be provided as gaseous carbon dioxide, which can be controlled with a gaseous carbon dioxide delivery system. The gaseous carbon dioxide delivery can overcome the shortcomings of conventional sodium bicarbonate delivery systems because it is less likely to malfunction, can be automated, and can utilize existing gaseous carbon dioxide delivery systems. Moreover, the carbon dioxide alkalinity modifier 153 can be used with various pH increasers 151 and acids 152. Similarly, the pH value and the alkalinity level in the aquatic application 204 can be controlled using the pH increaser 251 and the acid 252.

It will be appreciated by those skilled in the art that while the invention has been described above in connection with particular instances and examples, the invention is not necessarily so limited and that numerous other instances, examples, uses, modifications, and departures from the instances, examples, and uses are intended to be encompassed by the claims attached hereto. The entire disclosure of each patent and publication cited herein is incorporated by reference as if each such patent or publication were individually incorporated by reference herein. Various features and advantages of the invention are set forth in the following claims.

We claim:

1. An alkalinity generation system for an aquatic application, comprising:
a first chemical distribution mechanism configured to deliver a pH increaser to the aquatic application;
a second chemical distribution mechanism configured to deliver an acid to the aquatic application;
a first sensor designed to sense and communicate a pH value of the aquatic application;
a second sensor designed to sense and communicate an alkalinity level of the aquatic application; and
a controller designed to receive the pH value from the first sensor and the alkalinity level from the second sensor, the controller directing the first chemical distribution mechanism and the second chemical distribution mechanism to selectively modify the pH value and the alkalinity level of the aquatic application based on a pH value threshold and an alkalinity level threshold.

2. The alkalinity generation system of claim 1, wherein the controller comprises one or more of a primary controller and a chemical controller.

3. The alkalinity generation system of claim 2, wherein the one or more of the primary controller and the chemical controller are connected to an interface via a network, and wherein the interface provides a user with access to the one or more of the primary controller and the chemical controller.

4. The alkalinity generation system of claim 3, wherein one or more of the pH value threshold and the alkalinity level threshold are communicated to the one or more of the primary controller and the chemical controller across the network.

5. The alkalinity generation system of claim 1, wherein the pH increaser is one or more of potassium carbonate, sodium carbonate, or potassium hydroxide, and the acid comprises muriatic acid.

6. The alkalinity generation system of claim 5, further comprising a third chemical distribution mechanism designed to deliver an alkalinity modifier to the aquatic application, wherein the controller is designed to direct the third chemical distribution mechanism to selectively modify the alkalinity level of the aquatic application based on the alkalinity level threshold.

7. The alkalinity generation system of claim 6, wherein the alkalinity modifier comprises gaseous carbon dioxide.

8. The alkalinity generation system of claim 6, wherein the first chemical distribution mechanism comprises a first chemical pump, the second chemical distribution mechanism comprises a second chemical pump, and the third chemical distribution mechanism comprises an air stone in fluid communication with a valve.

9. The alkalinity generation system of claim 1, wherein the second sensor is a colorimeter.

10. A system for an aquatic application, comprising:
a first chemical distribution system designed to deliver a pH increaser to the aquatic application;
a second chemical distribution system designed to deliver an acid to the aquatic application;
a sensor designed to sense one or more water quality parameters of the aquatic application; and
a controller communicatively coupled to the sensor, the first chemical distribution system, and the second chemical distribution system, the controller designed to:
compare the one or more sensed water quality parameters to a water quality setpoint range to determine if the one or more water quality parameters are above or below the water quality setpoint range;
determine a chemical treatment plan designed to adjust the one or more sensed water quality parameters to be within the water quality setpoint range; and
implement the chemical treatment plan by selectively operating one or both of the first chemical distribution system and the second chemical distribution system.

11. The system of claim 10, wherein the one or more water quality parameters of the aquatic application include at least one of a pH value and an alkalinity level.

12. The system of claim 11, further comprising a third chemical distribution system configured to deliver an alkalinity modifier, wherein implementation of the chemical treatment plan further includes selectively operating the third chemical distribution system.

13. A method for controlling a water quality of an aquatic application, comprising:
sensing a first water quality parameter, where the first water quality parameter comprises an alkalinity level of the aquatic application;
determining if the alkalinity level is above or below an alkalinity setpoint range;
determining a chemical treatment plan designed to bring the alkalinity level of the aquatic application within the alkalinity setpoint range; and
implementing the chemical treatment plan by controlling one or more chemical distribution mechanisms to deliver one or more chemicals selected from a pH increaser and an acid to the aquatic application.

14. The method of claim 13, the method further comprising:
sensing a second water quality parameter, wherein the second water quality parameter comprises a pH value of the aquatic application; and
determining if the pH value is above or below a pH value setpoint range.

15. The method of claim 14, wherein determining the chemical treatment plan includes bringing the pH value of the aquatic application within the pH value setpoint range.

16. The method of claim 15, wherein the pH increaser is selected from the group consisting of potassium carbonate, sodium carbonate, potassium hydroxide, or combinations thereof, and the acid comprises muriatic acid.

17. The method of claim 16, wherein implementing the chemical treatment plan includes delivering an alkalinity modifier to the aquatic application.

18. The method of claim 17, wherein the alkalinity modifier comprises gaseous carbon dioxide.

19. The method of claim 13, wherein the alkalinity setpoint range is imparted with a value of about 80 ppm to about 120 ppm.

20. The method of claim 13, wherein determining the chemical treatment plan includes bringing a pH value of the aquatic application within a pH value setpoint range, and the pH value setpoint range is imparted with a value of about 7.2 to about 7.8.
